(19) United States
(12) Patent Application Publication
(10) Pub. No.: US 2003/0174391 A1
(43) Pub. Date: Sep. 18, 2003

(54) Gain flattened optical amplifier

(76) Inventors: Tao Pan, San Jose, CA (US); Richard E. Demaray, Portola Valley, CA (US); Yong Jin Xie, Cupertino, CA (US)

Correspondence Address: Finnegan Henderson Farabow Garrett & Dunner LLP, 1300 I Street NW, Washington, DC, 20005-3315, US

(21) Appl. No.: 10/101,493

(22) Filed: Mar. 16, 2002

(51) Int. Cl. H01S 3/00

(52) U.S. Cl. 359/341.41; 359/333

(57) ABSTRACT

A wave guide amplifier is presented which has a relatively flat gain over a band of wavelengths. In some embodiments, the amplifier is an erbium doped amplifier and the gain is flat to within 2.5 dB across the C-band. Gain flattening can be accomplished by adjusting the concentration of ground state rare earth ions so that a portion of the signal light is absorbed throughout the amplifier. Signal light at wavelengths corresponding to peaks in the emission spectrum tend to be absorbed more readily than other wavelengths, thereby flattening the gain characteristic of the amplifier.

### BACKGROUND

1. Field of the Invention

The invention is related to Erbium doped amplifiers and, in particular, to an Erbium doped planar amplifier with a gain that is relatively flat in the C-band.

2. Discussion of Related Art

The increasing prevalence of fiber optic communications systems has created an unprecedented demand for devices for processing optical signals. Planar devices such as optical waveguides, couplers, splitters, and amplifiers, fabricated on planar substrates, like those commonly used for integrated circuits, and configured to receive and process signals from optical fibers are highly desirable. Such devices hold promise for integrated optical and electronic signal processing on a single semiconductor-like substance.

The basic design of planar optical waveguides and amplifiers is well known, as described, for example, in U.S. Pat. Nos. 5,119,460 and 5,563,979 to Bruce et al., 5,613,995 to Bhandarkar et al., 5,900,057 to Buchal et al., and 5,107,538 to Benton et al., to cite only a few. These devices, very generally, include a core region, typically bar shaped, of a certain refractive index surrounded by a cladding region of a lower refractive index. In the case of an optical amplifier, the core region includes a certain concentration of a dopant, typically a rare earth ion such as an Erbium or Praseodymium ion which, when pumped by a laser, fluoresces, for example, in the 1550 nm and 1300 nm wavelength ranges used for optical communication, to amplify the optical signal passing through the core.

Erbium doped fiber amplifier (EDFA) technology has played a crucial role in the deployment of WDM systems in long haul communication systems. P. C BECKER, N. A. OLSSON and J. R. SIMPSON, ERBIUM-DOPED FIBER AMPLIFIERS FUNDAMENTAL AND TECHNOLOGY (1999). EDFAs can provide large gain and large output power for C-band (1528-1565 nm) or L-Band (1570-1610 nm) signals without introducing too much noise. P. C BECKER, N. A. OLSSON and J. R. SIMPSON, ERBIUM-DOPED FIBER AMPLIFIERS FUNDAMENTAL AND TECHNOLOGY (1999). Achieving higher gain in a shorter EDFA by increasing Er concentration has always been highly desirable. However, it has previously been found that higher Erbium concentration in EDWA enhance so-called “upconversion/clustering” effects, M. P. Hehlen, N. J. Cockroft, T. R. Gosnell, A. J. Bruce, G. Nykolak and J. Shmulovich, “Uniform upconversion in high-concentration Er³⁺-doped soda lime silicate and aluminosilicate glasses” Optics Letters, Vol.22, No. 11, Jun. 1, 1997; J. Philipsen, J. Broeng, A. Bjarklev, S. Helmfrid, D. Bremberg, B. Jaskorzynska and B. Palsdottir, “Observation of strongly nonquatratic homogeneous upconversion in Er³⁺-doped silica fibers and reevaluation of the degree of clustering”, IEEE Journal of Quantum Electronics, Vol. 35, No. 11, pp 1741, November 1999, which significantly reduces pump efficiency. Due to the high cost of optical pump sources, development efforts have focused on power efficiency and total output power of the amplifiers. See, e.g., B. Pederson, M. L Dakss, B. A. Thompson, W. J. Miniscalco, T. Wei and L. J. Andrews, “Experimental and theoretical analysis of efficient erbium-doped fiber power amplifier” IEEE Transactions Photonics Technology Letters, Vol. 3, No. 12, pp 1085, December 1991; M. Ohashi, “Design Considerations for an Er³⁺-doped fiber amplifier”, J. Lightwave Technology, Vol. 9, No. 9, September 1991.

High Erbium concentrations have been avoided in conventional Erbium doped amplifiers, both in fibers and in planar waveguides, mostly because of the concentration quenching substantially related to high concentrations of Er ions. Some recent work in new host materials have rekindled interest in high Erbium concentration amplifiers. See, e.g., S. Jiang, B. Hwang, T. Luo, K. Seneschal, F. Smektala, S. Honkanen, J. Lucas and N. Peyghambarian, “Net gain of 15.5 dB from a 5.1 cm-long Er³⁺-doped phosphate glass fiber”, OFC'2000, Mar. 7-10 Baltimore. Erbium doped fibers typically have Er ion concentrations below about 1×10¹⁹/cm³.

Two of the major upconversion mechanisms in the high Er concentration region are homogeneous upconversion (HUC) and pair induced quenching (PIQ). FIG. 1 shows an energy level diagram for Erbium ions along with the energy diagrams for Ytterbium ions. In some typical operations, the Er³⁺ ions are pumped with about 980 nm light in the transition ⁴I_{15/2} =>⁴I_{11/2} transition which decays to the ⁴I_{13/2} level. Signals are amplified in the transition from ⁴I_{13/2}=>⁴I_{15/2}, the ground state level. It is well known to activate the Erbium ions with Ytterbium ions, which can be pumped with relatively weak 980 nm light in the ²F_{7/2}=>²F_{5/2} transition. The Ytterbium absorption cross section is much larger than the corresponding Erbium Absorption cross section around 980 nm and the energy transfer between Ytterbium and Erbium is also efficient.

The typical lifetime of Erbium ions in a typical Erbium doped fiber at the I_{13/2} energy level is around or above about 10 ms in a good Erbium doped fiber. Homogeneous up-conversion is typically not an issue in most fiber amplifiers because there is only a small amount (<2%) of Er clustered together, depending on the host material of the fiber. Therefore, the threshold of pump power is low and pump power efficiency and output power are high.

Most Erbium doped fibers, however, provide an uneven gain spectrum in the C-band, P. C BECKER, et al., due to intrinsic uneven Erbium emission spectrum as shown in FIG. 2, and relative uniform inversion in the transverse plane of the doped (e.g., core) region. Since, as shown in FIG. 2, the absorption and emission spectra are not symmetric in a doped fiber, flattening the gain is difficult by adjusting pump power. The gain spectrum can be slightly adjusted by modifying the length of Erbium doped fiber and pump power. With longer lengths, the gain variation attenuation becomes limited. Even by optimizing pump power and Erbium doped fiber length, the gain is relative flat for a narrow range of input power. Once the input power fluctuates too much, the gain spectrum will not be flat again. Conventionally, a gain flattening filter is added after the amplifier, especially in cascaded amplifier applications. See Y. Sun, A. Srivastava, J. Zhou and J. W. Sulhoff, “Optical fiber amplifiers for WDM optical networks”, Bell Labs Technical Journal, pp. 187, January-March 1999. The gain flattening filter has an absorption spectrum which absorbs the peak emission which occurs at around 1530 nm while not absorbing as strongly at wavelengths below or above the 1530 nr peak. The resulting overall gain of the amplifier can, in that fashion, be relatively flat across the entire band. Typical gain flattening filter technologies can be filter based or grating based. Gain flattening to provide even signal amplification across the C-band of the signal wavelengths in WDM systems is important for maintaining the relative intensities of those signals. However, adding filters also provides higher noise characteristics and reduces pump efficiency.

Therefore, there is a need for an optical amplifier with relatively flat gain characteristics across the band of signal wavelengths without the necessity of providing gain flattening filters.

### SUMMARY

In accordance with the present invention, a rare-earth doped waveguide amplifier with signal gain which is relatively flat over a band of wavelengths is presented. In some embodiments, the amplifier includes an Erbium doped core material with an Erbium concentration having mono-dispersed Erbium ions and a concentration of Erbium ions involved in unsaturable absorption (i.e., unsaturable Erbium ions). In some embodiments, the core material may further be doped with a sensitizer, for example Ytterbium ions. In some embodiments, the gain of an amplifier according to the present invention is relatively flat substantially across the C-band. In some embodiments, the dopants for the core material may include other rare earth ions in order to provide an amplifier flat across a different band of wavelengths. Other active amplifier dopants can include Ce, Pr, Nd, Pm, Sm, Eu, Gd, Tb, Dy, Ho, Er, Tm Yb, for example.

As a gain flattening mechanism, for Erbium dopant, for example, the absorption due to the ground state population maintained by the unsaturable Erbium ions is distributed absorption in that in each cross-sectional plane of the amplifier this is proportional amounts of excited state and ground state Erbium ions. The ground state Erbium ions can then absorb the 1530 nm light more strongly than other wavelengths in the C-band, thereby quenching an emission peak which occurs around 1530 nm. This effectively reduces the “non-flatness” of the gain parameter spectrum substantially across the C-band of the amplifier in each cross-sectional plane of the amplifier. Other dopants may be utilized in gain-flattened amplifiers across other optical bands.

In some embodiments, the index contrast (Δn/n) between the core and a cladding material surrounding the core can be high (greater than about 2%) to facilitate confinement of the pump beam and create a varying inversion concentration as a function of distance from the center of the core, which contributes to the gain flatness.

For a particular level of active dopant concentration and index contrast, the physical dimensions (i.e., thickness, width and length) can be chosen such that the gain characteristics of the amplifier are flat across the C-band. Further, pump power can be adjusted to further flatten the gain across the C-band.

These and other embodiments are further discussed below with respect to the following figures.

### BRIEF DESCRIPTION OF THE FIGURES

FIG. 1A shows Erbium and Ytterbium energy level diagrams.

FIG. 1B illustrates up-conversion processes in an amplifier according to the present invention.

FIG. 2 shows absorption and emission curves over the C-band for a typical 1550 nm Erbium doped fiber amplifier.

FIGS. 3A through 3F show cross sections of embodiments of waveguide amplifiers according to the present invention.

FIG. 3G shows the pump power density as a function of location in the waveguide.

FIG. 4A shows a cross section of a fiber amplifier.

FIG. 4B shows the pump power density as a function of location in the fiber amplifier shown in FIG. 4A

FIGS. 5A and 5B illustrate the concentration of excited-state Erbium ions as a function of pump power for various Erbium-doped amplifiers.

FIG. 6 shows an ASE curve for an embodiment of a waveguide amplifier according to the present invention.

FIG. 7 shows a photoluminescence spectrum of the embodiment of waveguide amplifier shown in FIG. 6.

FIG. 8 shows a gain curve for an embodiment of a waveguide amplifier according to the present invention.

FIG. 9 shows gain versus length of the amplifier for the waveguide amplifier shown in FIG. 8.

FIG. 10 shows the emission spectrum of a co-doped waveguide according to the present invention.

FIG. 11 shows the gain coefficient spectrum of a co-doped waveguide according to the present invention.

FIG. 12 shows gain characteristics of a waveguide according to the present invention.

FIG. 13 shows a high pump power low signal power gain spectrum.

FIG. 14 shows gain characteristics of a waveguide according to the present invention.

FIG. 15 shows gain characteristics of another waveguide according to the present invention.

### DETAILED DESCRIPTION

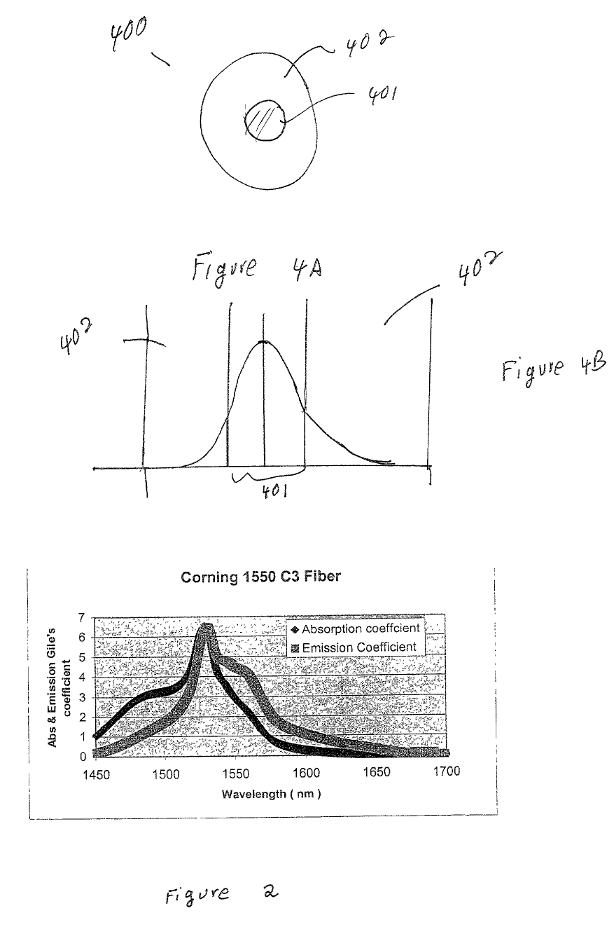

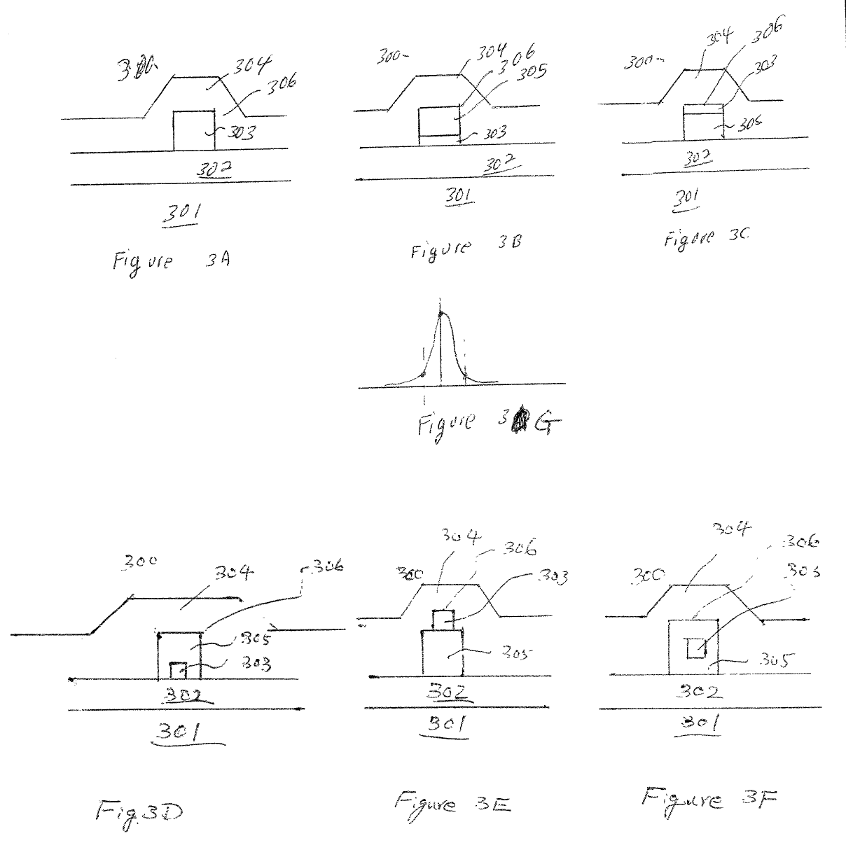

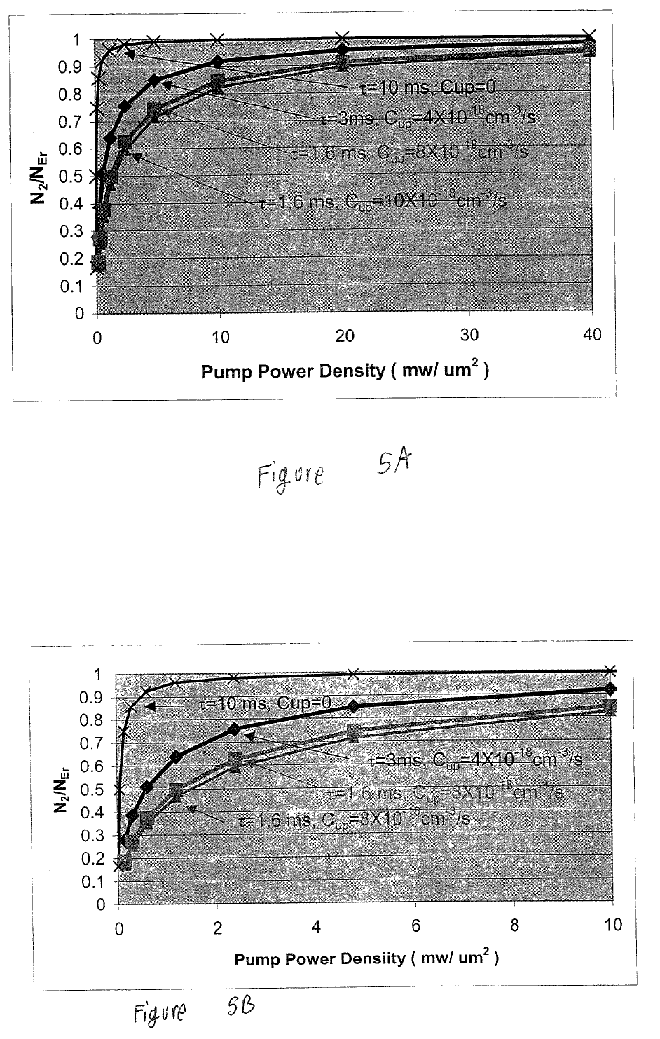

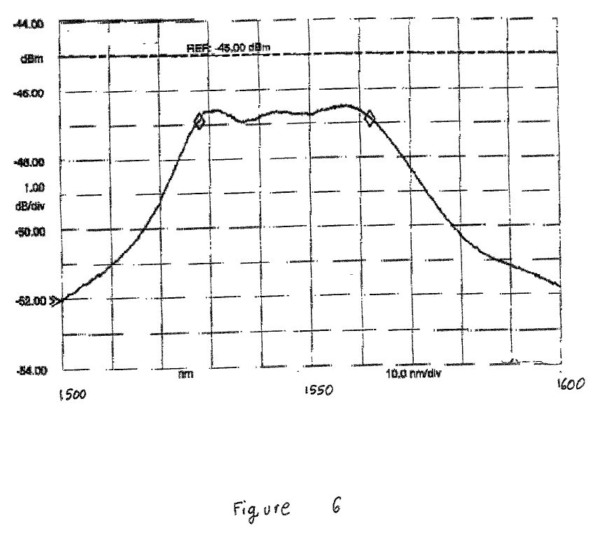

FIGS. 3A through 3C show a cross-section of waveguide amplifiers according to the present invention. An undercladding layer 302 is deposited over a substrate 301. In some embodiments, undercladding layer 302 can be a thermal oxide. In some embodiments, undercladding layer 302 can be quartz (in which case substrate 301 is also quartz). In some embodiments, undercladding layer 302 can be a deposited layer with an index lower than core 306. In FIGS. 3A and 3B, a rare-earth doped, for example Erbium doped or possibly Erbium and Ytterbium co-doped, layer is deposited over undercladding layer 302 to form an active layer 303. In amplifier 300 as shown in FIG. 3C, a passive layer 305 is deposited over undercladding layer 302 and active layer 303 is deposited over passive layer 305. In amplifier 300 as shown in FIG. 3B, passive layer 305 is deposited over active layer 303. Layers 303 and 305 are then patterned to form a core 306. In FIG. 3A, all of core 306 is active. In FIG. 3B, core 306 includes a passive core 305 over an active core 303. In FIG. 3C, core 306 includes an active core 303 over a passive core 305.

FIG. 3D shows another embodiment of amplifier 300. In the embodiment shown in FIG. 3D, active layer 303 is deposited over undercladding layer 302 and patterned. Passive layer 305 is then deposited over patterned active layer 303 and patterned to form core 306.

In the embodiment of amplifier 300 shown in FIG. 3E, passive layer 305 is deposited on undercladding layer 302 and patterned. Active layer 303 is then deposited over passive layer 305 and patterned such that an active layer is positioned over the passive layer to form core 306. Active layer 303 is first patterned and then passive layer 305 is patterned.

In the embodiment of amplifier 300 shown in FIG. 3F, a passive layer 305 is partially deposited and active layer 303 is deposited and patterned. The deposition of passive layer 305 is then completed and passive layer 305 is patterned to form 306.

Finally, an upper cladding layer 304 is deposited over core 306. The resulting waveguide 300 can be of any length and shape, including S shapes and other shapes in order to provide any length of amplifier. Core 306, as shown, has a rectangular shape described by a width, a length, and the properties of active layer 303 and passive layer 305.

The thickness of active layer 303 is typically about 0.5 to 2 μm, but can actually be any thickness. The thickness of passive layer 305 is typically about 3 to 8 μm. In some embodiments, if core 306 is entirely active layer 303, it can between 0.1 to 6 μm in thickness. The width of core 306 is typically about 1 to 5 μm, but can actually be any width as well. The thicknesses of cladding layers 302 and 304 are about 10 μm. The index of refraction of both cladding layers 302 and 304 and active layer 303 and passive layer 305 is dependent on the actual deposition parameters of those layers. The percentage change in index or the index contrast Δn/n can be tailored by varying material composition and material deposition parameters to adjust the individual indices of refraction for each of layers 302, 303, 304 and 305 for particular device needs. The dopant ion concentration of active layer 303 is typically determined by the composition of the target utilized in the deposition and the deposition process. Examples of some targets utilized in deposition are described in U.S. application Ser. No. {Attorney Docket No. M-12247 US} (the '247 application), filed concurrently with the present invention, assigned to the same assignee as is the present invention, and herein incorporated by reference in its entirety. Methods of depositing layers resulting in cladding layers 302, 303, 304 and 305 are described in U.S. application Ser. No. 09/903050 (the '050 application), “Planar Optical Devices and Methods for their Manufacture”, by Demaray et al., filed Jul. 10, 2001, assigned to the same assignee as is the present application, herein incorporated by reference in its entirety, and U.S. application Ser. No. {Attorney Docket No. M-12245 US} (the '245 application), filed concurrently with the present application, assigned to the same assignee as is the present application, herein incorporated by reference in its entirety. Further, a tapering of waveguide 300 in order to enhance optical coupling into and out of core 306 is described in U.S. application Ser. No. {Attorney Docket No. M-12138 US} (the '138 application), filed concurrently with the present application, assigned to the same assignee as is the present application, and also incorporated herein in its entirety. Targets for deposition processes are described in U.S. application Ser. No. {Attorney Docket No. M-12247 US} (the '247 application), filed concurrently with the present application, assigned to the same assignee as is the present application, herein incorporated by reference in its entirety.

The following discussion refers in particular to erbium doped cores for amplifier 300. However, one skilled in the art will understand than core 300 may be doped with other rare earth ions or combinations of rare earth ions.

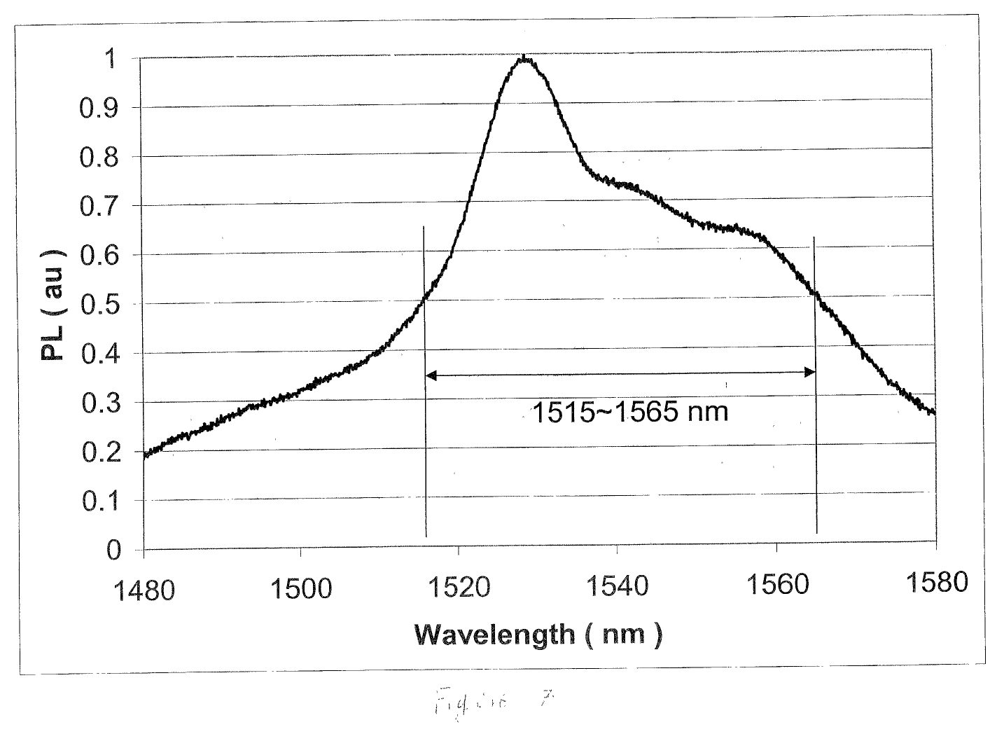

In contrast, FIG. 4A shows a cross section of an erbium doped fiber amplifier. Fiber amplifier 400 includes a core 401 and a cladding 402 surrounding core 401. In a Corning 1550 C3 fiber, for example, core 401 has a radius of about 1.5 μm and cladding 402 has a radius of about 125 μm. In some cases, the radius of core 401 does not coincide with the radius of erbium doping. Erbium concentrations are typically low in Erbium doped fibers such as that shown in FIG. 4A, for example less than about 1×10¹⁹ cm⁻³. The lifetime of the first Erbium excited state, I_{13/2} is about 10 ms. As discussed above, the low concentration of Erbium results in a low percentage of unsaturable Erbium (i.e., forming interacting pairs or larger groupings of Erbium ions), resulting in negligible amounts of up-conversion or other processes detrimental to efficient amplification.

In a typical amplifier, either a waveguide amplifier such as amplifier 300 shown in FIGS. 3A through 3C or a fiber amplifier such as amplifier 400 shown in FIG. 4, the signal increase per length can be expressed, according to the Gile's theory, C. Randy Giles and Emmanuel Desurvire, “Modeling Erbium-Doped Fiber Amplifier”, J. of Lightwave Technology, Vol. 9, No. 2, pp 271, 1991, as

$$\frac{\partial P ( z , {λ}_{i}^{s} )}{\partial Z} = {∯}_{{WG}_{ Area}} ( {N}_{2} ( x , y , z ) {σ}_{e} ( {λ}_{i}^{s} ) - {N}_{1} ( x , y , z ) {σ}_{a} ( {λ}_{i}^{s} ) ) {I }_{i}^{s} ( x , y , z , {λ}_{i}^{s} ) ⅆ x ⅆ y - {α}^{s} P ( z , {λ}_{i}^{s} ) \qquad ( Eq . 1 )$$

In Eq. 1, z is the direction along the amplifier and x and y are in the cross-sectional plane of the amplifier. P(z, λᵢ^{s}) is the signal power averaged over the cross-section of amplifier with wavelength λᵢ^{s} at location z of fiber or waveguide. The parameter α^{s} is the signal propagation loss in the amplifier waveguide.

The parameters N₂ (x, y, z) and N₁ (x, y, z) are the Erbium ion volume densities for Erbium ions in the I_{13/2} excited state and Erbium ions in the I15/2 ground state, respectively, as a function of position. N₂ (x, y, z) and N₁ (x, y, z) are therefore determined by pump power and signal power densities at each location (x, y, z).

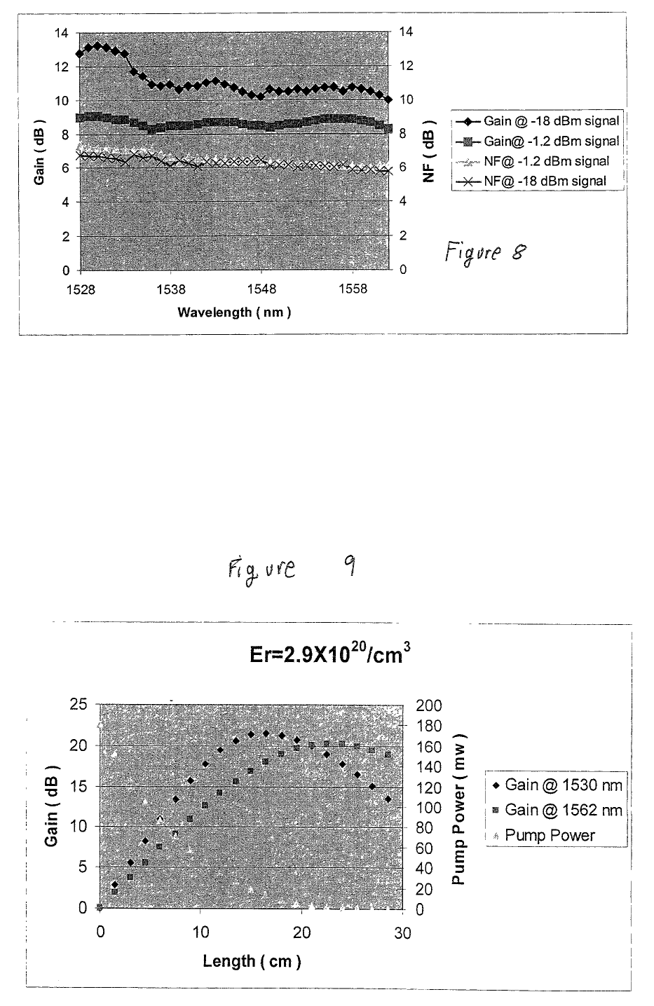

FIGS. 5A and 5B show the ratio of N₂ over the total Erbium concentration N_{Er} as a function of pump power for various excited state lifetimes and up conversion constants. In optical fibers, for example, Cᵤₚ is substantially 0 and the lifetime is about 10 ms. In planar waveguides, the Erbium concentration is much higher and Cᵤₚ and the excited-state lifetimes can be adjusted by target material and deposition parameters. See, e.g. the '247 application, the '050 application, and the '245 application. FIG. 5A illustrates the concentration of Erbium ions in the excited state of fiber (τ=10 ms) and examples of planar waveguide amplifiers with lifetimes τ=3, 1.6 and 1.6 ms, respectively, and up-conversion constants Cᵤₚ being 4×10⁻¹⁸ cm⁻³/s, 8×10⁻¹⁸ cm⁻³/s and 10×10⁻¹⁸ cm⁻³/s, respectively. FIG. 5B illustrates the concentrations shown in FIG. 5A for low pump powers. In FIGS. 5A and 5B, the signal power is low so that the amount of Erbium in the excited state is little affected by the signal. In operating amplifiers built on these materials, amplifiers have a flat gain characteristic over a large range of signal powers (for example, between about −30 dBm to about 10 dBm).

In FIGS. 5A and 5B, the curve corresponding to lifetime of 3 ms and up conversion constant about 4×10⁻¹⁸ can be deposited from a ceramic target with composition 54.5 cat. % SiO₂, 44.5 cat. % Al₂O₃, and 1.0 cat. % Er₂O₃ as described in the '247 application in a RF sputtering process as described in '050 application. The curve corresponding to lifetime 1.6 ms and up conversion constant about 8×10⁻¹⁸ cm⁻³/s can be deposited from a metallic target with composition 50 cat. % Si, 48.5 cat. % Al, and 1.5 cat. % of Er as described in the '247 application in an RF sputtering process as described in the '050 application annealed at 850° C. The curve corresponding to a lifetime of 1.6 ms and up conversion constant about 10×10⁻¹⁸ cm⁻³/s can be deposited as described in the layer giving the up conversion constant about 8×10⁻¹⁸ cm⁻³/s except that the anneal is done at 725° C.

In Eq. 1, the parameter σₑ(λᵢ^{s}) and σₐ(λᵢ^{s}) refer to the emission and absorption cross sections as a function of signal wavelength, respectively. Further in Eq. 1, Iᵢ^{s} (x, y, z, λᵢ^{s}) is the signal power density with wavelength λᵢ^{s} at location (x, y, z) location. In the examples described for discussion here, small signal powers are considered. Since small signals should not change the concentration of excited state Erbium ions in the amplifier, only pump power density will significant effect on the excited state concentration N₂.

In a typical C-band Erbium doped fiber 400 (see FIG. 4A) such as, for example, a Coming 1550 C3, the lifetime of the Er³⁺ excited state (I_{13/2}) is about 10 ms. Due to the low concentration of Er ions and the high quality of the host material in the Corning fiber, homogeneous up-conversion (HUC) can mostly be ignored in the Corning amplifier. It is estimated that less than about 2% of the total Erbium ions in the Corning fiber form pairs or other clusters. The threshold pump power density for this fiber, the pump power where N_{2/}N_{Er} becomes greater than 50% which indicates inversion, is estimated to be around 0.05 mw/um². If Er ion concentration at the I_{11/2} state can be neglected, then N₂ and N₁ for fiber 400 can be approximated to be uniform across the transverse plane for pump power densities above about 1 mw/um². Even though the Erbium ions are pumped into the I11/2 state, the transition lifetime from I_{11/2} to I_{13/2} is very short, typically less than about 50 μs. Therefore, Erbium ions pumped into the I_{11/2} state quickly transition to the I_{13/2} state leaving little to no concentration of Erbium ions in the I_{11/2} state.

For fibers, the average values for N₂ and N₁ in the transverse plane can be introduced in Eq. 1, leaving N₂ and N₁ as functions of z alone, which is a typical treatment for calculating the gain in the Gile's model, see C. Randy Giles and Emmanuel Desurvire, “Modeling Erbium-Doped Fiber Amplifier”, J. of Lightwave Technology, Vol. 9, No. 2, pp 271, 1991. This treatment also introduces a very simple concept of confinement factor to simplify the modeling process. In the Corning 1550 C3 fiber, for example, the numerical aperture (NA) is about 0.23, the mode-field diameter (MFD) is about 3.34 um @1000 nm, the Er dopant radius is about 1.5 um and core radius is about 1.5 um. FIG. 4B shows the pump power density as a function of cross-sectional location in a typical fiber. The typical pumping wavelength is about 980 nm, and therefore the MFD is approximately 3.34 as listed above. In the fiber, therefore, a significant amount of the pump power lies outside of active core 401. The pump power density at the center of this fiber is about three times higher than at the edge of Erbium dopant region (i.e., core 401).

If a 50 mW pump is used for the Coming Erbium doped fiber amplifier (EDFA), the pump power density in the beginning section of the Erbium doped fiber is about 10 mW/um² at the center and 3.5 mW/um² at the edge of core 401. Since, as is seen in FIGS. 5A and 5B, the population inversion (N₂/N_{Er}) can be well above 95% at both the center of core 401 and the edge of core 401, despite the factor of three difference in pump power density between the center of core 401 and the edge of core 401. The gain spectrum from a short fiber, then, can be expected to resemble the shape of emission cross section or photo-luminescence (PL) spectrum shown in FIG. 2. Because of the low signal power, back ASE (amplified stimulated emission) is assumed not large enough to deplete inversion at the beginning of the fiber. If the fiber is longer, the pump power density could drop below 1 mW/um² at the end of the fiber. At the same time, forward ASE power (>2 mw) is high enough to continue pumping Erbium ions, resulting in some flattening of the gain. However, the inversion won't be as high as at the beginning the fiber. If the pump power is reduced to create a significant inversion non-uniformity across the fiber, there would be insufficient pump power to provide useful amplification or lose gain flattening if the input power is increased.

Further, the gain coefficient spectrum close to the end of a long Erbium doped fiber is biased toward longer wavelengths due to re-absorption of the shorter wavelengths. Therefore, the gain spectrum could be flatter in a long fiber than a short fiber. Although it is unclear that the average inversion model can still be used in this low pump power region, EDFA developers use it anyway. One of the disadvantages to utilizing long fibers is that the output power will drop, which violates the design rules for power amplifiers even for some pre-amp applications in long-haul telecommunications applications.

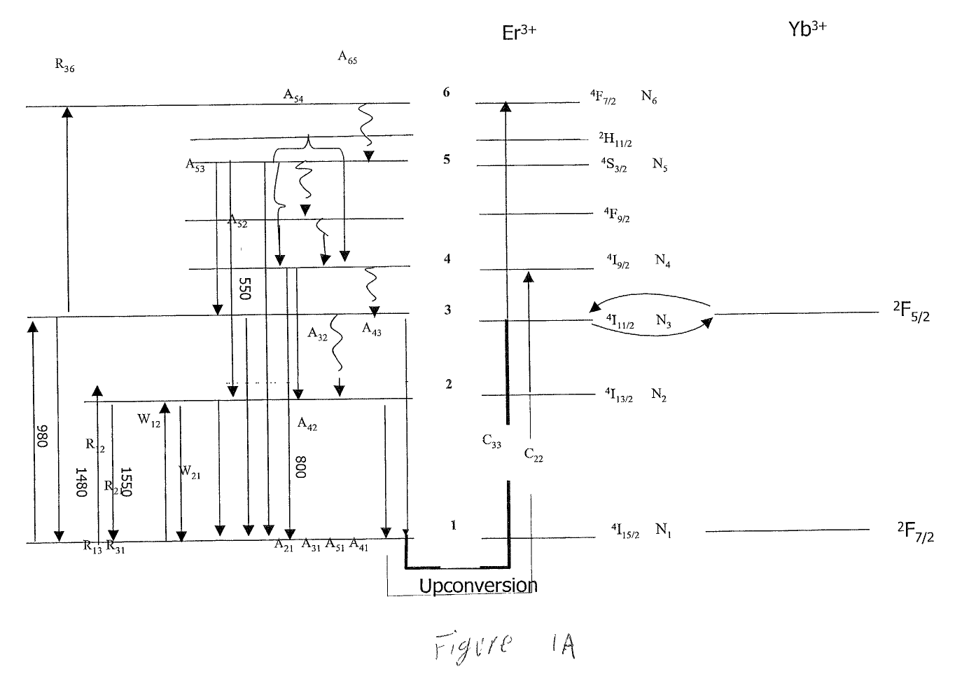

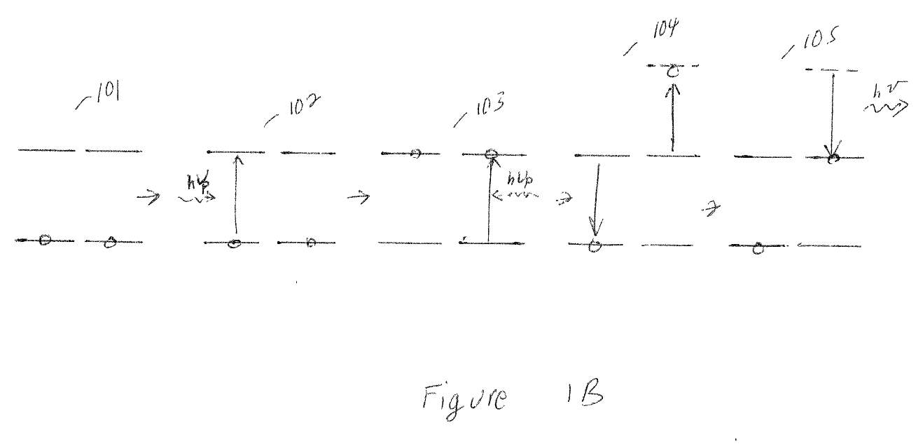

Erbium doped waveguide amplifiers (EDWA) opens a route to low cost optical amplifier solutions for metro applications due to the potential for compact size and easy integration with other passive function. As is generally considered detrimental, due to the high concentrations of Erbium ion dopants in a waveguide amplifier, EDWAs are known to have homogeneous up-conversion (HUC) and pair-induced quenching (PIQ) problems. Both HUC and PIQ processes for erbium ions are illustrated on the energy level diagrams shown in FIG. 1. When two neighboring Erbium ions are each at the first excited state I_{13/2}, and the distance between those two Erbium ions is sufficiently close, one of Erbium ions can be excited to a higher excited state by the other Erbium ion. HUC is hard to avoid at high Erbium concentrations, even if the Erbium ions are mono-dispersed throughout the host material matrix. HUC happens in around a ms time frame. PIQ, however, happens within a few micro-seconds since the two interacting Erbium ions are generally closely packed. FIG. 1 shows upconversion transitions in one of the pair between the I_{11/2} energy level and the F_{7/2} energy level while the other erbium ion transitions typically to the ground state.

To overcome the HUC and PIQ problems, as well as other unsaturable-Erbium processes (i.e., processes that result in absorption of pump power without contributing to the I_{13/2} excited state population inversion or removing ions from the excited state population without returning the ion to the ground state), higher pump powers are typically utilized. Higher pump powers require optical pumps that are more expensive than the pumps that supply lower pump powers appropriate for optical fiber applications.

As is shown in FIGS. 5A and 5B, the dependence of inversion (N₂/N_{Er}) on pump power in waveguide amplifiers is much steeper below about 20 mw/um² than is the dependence in fiber amplifiers. This is often attributed to the higher levels of HUC in EDWA compared to the substantially absent HUC in EDFA. Therefore, a non-uniform inversion can be created on each transverse plane of the waveguide. Therefore, the gain coefficient spectrum in waveguide amplifiers can be very different from the emission or photo-luminescence (PL) spectrum.

As an example, consider an amplifier waveguide 300 as shown in FIGS. 3A with an I_{13/2} excited state lifetime of about 1.6 ms, up-conversion constant Cup about 10×10⁻¹⁸ cm³/s, Erbium concentration of about 4.5×10²⁰/cm³, with a waveguide thickness about 1.2 μm and a width about 3 um. Further, the index of refraction of core 306, which is active layer 303, is about 1.511. Bottom cladding 302 of amplifier waveguide 300 is about 1.4458 and the top cladding 304 is about 1.4565 (Δn/n being about 3.7%). If waveguide 300 according to this example is pumped with about 50 mW of 980 nm light, the power density at the center of waveguide could be five times (33 mW/um²) higher than the power density at the edge (6 mW/um²). FIG. 3G depicts the pump power density as a function of distance from the center of core 306. The power density at the center and the power density at the edge can be calculated, for example, by BPM_CAD from Optiwave, Inc., Ottowa, Ontario. As is shown in FIGS. 5A and 5B, the excited-state inversion N₂/N_{Er} is about 92% at the center and only about 72% percent at the edge of core 306. The resulting amplification of a signal at 1530, which is the peak of the typical emission spectrum, therefore will not be as favored due to reabsorption of the 1530 nm signal by ground-state Erbium, resulting in a 1530 nm quenching induced flattening of the gain across.

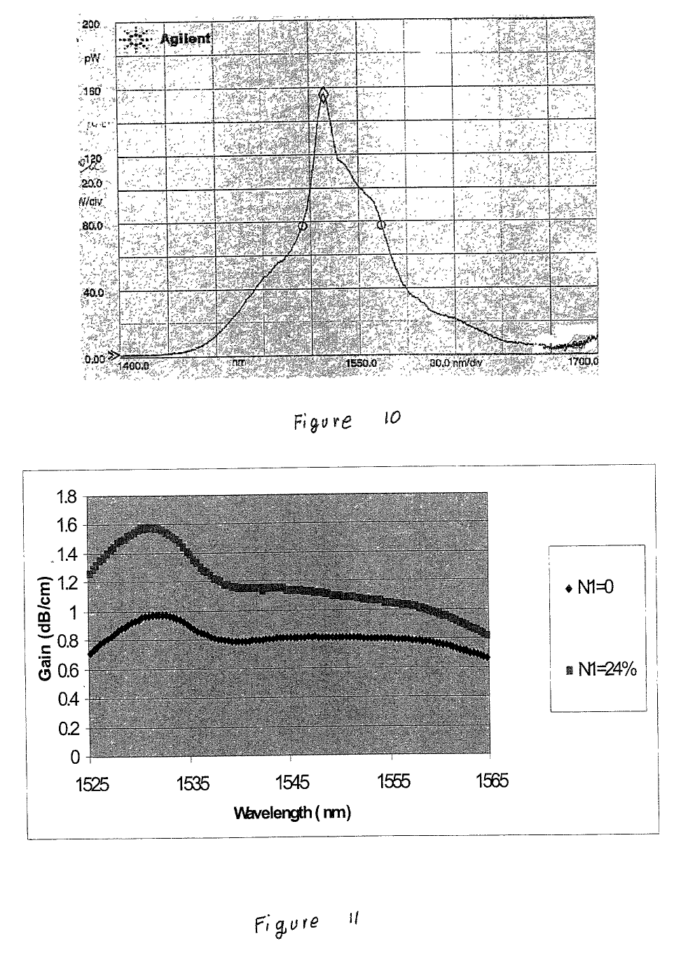

Therefore, even in a short (3 cm long) waveguide amplifier, the gain spectrum can be different from the photoluminescence spectrum. FIG. 6 shows the ASE spectrum of a 3 cm long waveguide as described above. The forward ASE spectrum in FIG. 6 closely resembles the small signal gain (e.g., powers less than about −10 dBm) spectrum and has only about 1 dB variation across substantially the entire C-band. The large difference of pumping power density between the center and the edge of doped core 301, which is due to a large index difference between core 301 and cladding 302 (Δn/n>about 2%), is due to very high index contrast achieved by deposition of core material and cladding material as described in the '050 application and the '245 application.

FIG. 7 shows the emission spectrum of a waveguide according to the example described here. Both the emission spectrum shown in FIG. 7 and the emission spectrum shown in FIG. 2 show a large 1530 nm emission and a smaller 1550 nm emission peak. An amplifier formed from the material shown in FIG. 7 is discussed later in Example 3 below.

Another significant contribution to the gain flatness is from controlling the erbium clustering. The smallest cluster, for example, results in pair-induced quenching (PIQ). It is not uncommon to find 25% of the Erbium ions forming pairs in high Erbium concentration doping condition. Since PIQ is a very fast process and it is very hard to excite the second Erbium ion in the pair with limited pump power density, there is about 12% of the Erbium ions staying at ground state throughout the core due to this process. By utilizing higher pumping powers, the gain spectrum could be flattened with higher PIQ concentrations. The penalty of providing higher pump powers to flatten the gain through a waveguide amplifier is particularly offset by the reduced cost of providing gain flattening filters.

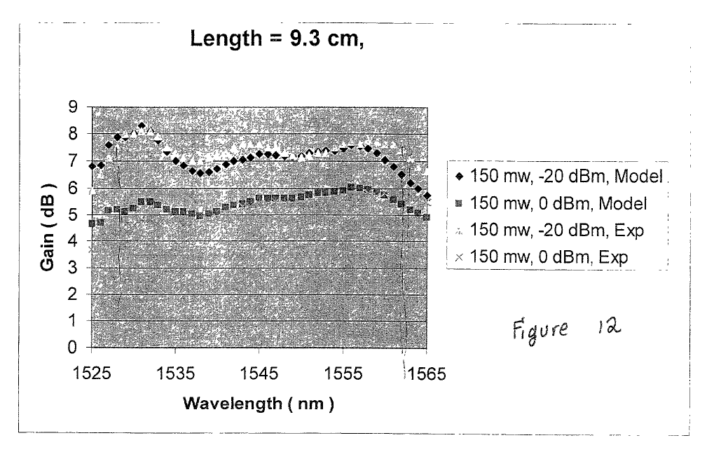

With lower upconversion constants (e.g., corresponding to lower concentrations of Erbium ions), the gain spectrum can still be flattened by providing relative long waveguide. A gain spectrum of 12.5 cm long waveguide with an Erbium concentration of about 2.9×10²⁰ cm⁻³ and upconversion constant of 4.5×10⁻¹⁸ cm³/s is shown in FIG. 8. In FIG. 8, the waveguide is pumped with 180 mW of 980 nm light. Both low power signals (about −18 dBm) and higher power signals (about −1.2 dBm) are shown. Also shown are the noise factors (NF) for low power signals and high power signals. Although already relatively flat across the C-band, a flatter gain curve can be achieved by adjusting the pumping power.

FIG. 9 shows a curve of the gain at a 1530 nm and 1562 nm as a function of the length of the waveguide. The waveguide is pumped with about 180 mW of 976 nm light. The gain as a function of length for 1530 nm and 1562 nm light is shown. At about 20 cm in length, the two curves intersect. Therefore, there will be a relatively flat gain characteristic between 1530 nm and 1562 nm light for about a 20 cm length waveguide pumped at about 180 mW of 976 mn light.

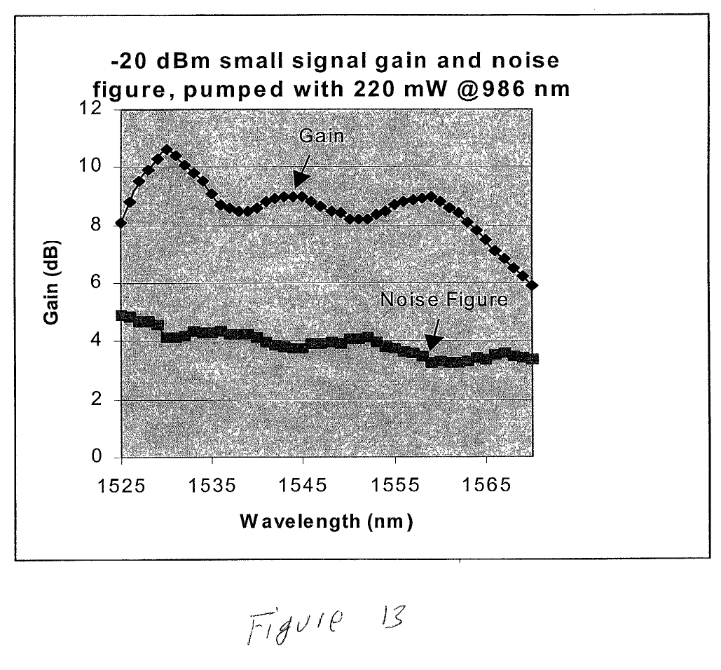

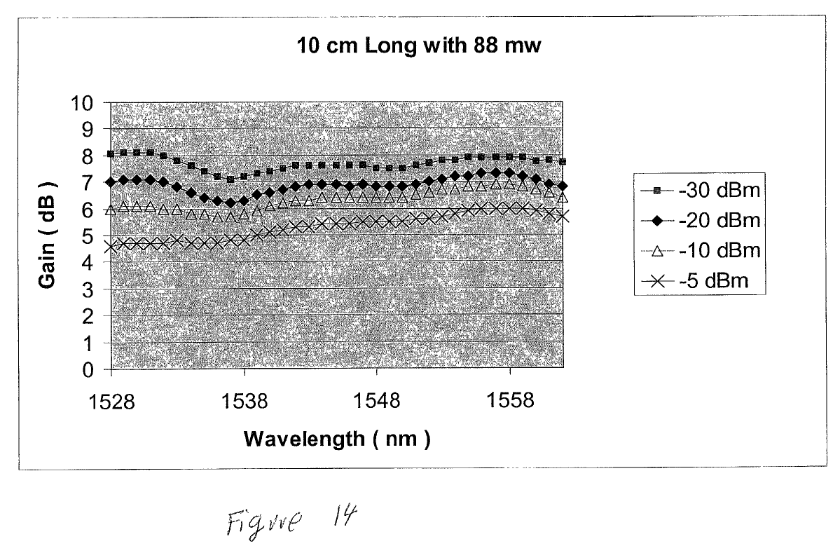

In some embodiments, the gain can be flattened in a waveguide amplifier by co-doping with a sensitizer, for example Ytterbium. Ytterbium co-doping with Erbium helps absorption of the pump power. At the same time, due to the back transfer process from Er to Yb ions, there is an enhanced percentage of Er at the ground state in Yb/Er co-doping material than in Er only materials. FIG. 10 shows a photoluminescence spectrum of Er/Yb co-doped material with Erbium concentration of 2.3×10²⁰ cm⁻³ and Yb concentration of about 2.3×10²⁰ cm⁻³. FIG. 11 shows a projected gain coefficient spectrum for N₁=0 and 24%, achieved at an estimated 200 mw of 980 mn pump power. The gain coefficient spectrum with N₁=24% s much flatter than N₁=0. The gain spectrum for 9.3 cm long waveguide is shown in FIG. 12.

The ability to gain flatten can be accomplished by creating a non-uniform population inversion across the cross section of a waveguide amplifier or otherwise create a significant ground state population in core 303 and depends on the ability to keep a concentration of ground-state Erbium ions during pumping. The concentration of unsaturable Erbium, which contributes to both pair-induced quenching (PIQ) and up-conversion (HUQ), is related to the remaining ground state population by providing alternative mechanisms for Erbium ions to transition back to the ground (I_{15/2}) state without transitioning to the long-lifetime excited state I_{13/2}. The combination of dark Erbium absorption of the pump and the high level of non-uniformity in pump power created by high-index contrasts between the center of the core and the edge of the core create large non-uniformity in population inversion across the cross-section of the core. As a result of this highly non-uniform population inversion, the amplified signal at 1530 nm (which is a peak of the emission curve) is re-absorbed by the ground state Erbium. The gain at 1530 nm, therefore, is slightly quenched by the ground state absorption. The gain at 1562 nm and the gain at 1530 mn, then, can be adjusted by a combination of waveguide length and pump power to flatten the gain of the amplifier.

In some embodiments, due to the distribution of unsaturable erbium throughout the amplifier waveguide, the gain can be flattened over a broad range of input signal powers (for example about −30 dBm to about −5 dBm, and in general between about −40 dBm and 10 dBm). The absorption of signal and possibly pump light is distributed along the length of the waveguide, which is often referred to as distributed absorption. Typical erbium doped fiber amplifiers can provide relative flat gain for a very narrow range of input powers (for example over less than about a 5 dB range). C. McIntosh, G. Williams, Y. Deiss and Jean-Marc_Delavaux, “Gain Flatness of a 30 dBm tandem Er-Er/Yb double-clad fiber amplifier for WDM transmission”, OFC'2002, WJ6, Anaheim, Calif., 2002.

There are several ways to measure the concentration of unsaturable Er ions. One method includes comparing the absorption per unit length and the gain per unit length with the maximum pump power at the wavelength where the absorption cross section is the same as the emission cross section, for example 1530 nm for an alumina-silica 1.0 cat % Er waveguide. If the gain does not match the absorption under high pump power in a short waveguide (about 1 cm in length), there are unsaturable Erbium ions present in the waveguide.

A second method involves measuring the un-saturable absorption. See, e.g., J. Nilsson, B. Jaskorzynska, and P. Blixt, “Performance Reduction and Design Modification of Erbium-Doped Fiber Amplifiers Resulting from Pair-Induced Quenching,” IEEE Phot. Tech. Lett., Vol. 5, No. 12, p. 1427, December, 1993. The unsaturable absorption refers erbium ions situated to interact with any defect which can receive the energy from the erbium ion, for example clustered erbium or erbium coupled to OH ions, and other defects. Unsaturable erbium leads to transmission loss even in the presence of high maximum pumping power. If there are unsaturable Erbium ions, there is always noticeable transmission loss in a short waveguide, even when the pump power reaches no higher than about 500 mW. Otherwise, the transmission loss of pump power through a short waveguide will be very small (typically below about 0.05 dB).

Therefore, in some embodiments the gain is flattened by obtaining a material for core material 306 with a significant concentration of unsaturable Erbium. In some embodiments, the gain is flattened to within about 5 dB of gain variation over the entire C-band (1528 to 1562 nm), and typically less than about 2.5 dB of gain variation (i.e. ripple). In some embodiments, the paired Erbium concentration is a significant proportion of the total Erbium concentration, for example greater than about 4%. Further, in some embodiments, the gain is flattened by obtaining a core material 303 where the homogeneous up-conversion constant is high, for example greater than 1×10⁻¹⁸ cm³/s. High up-conversion constants and high concentrations of paired Erbium ions can be controlled by controlling the Erbium concentration of material deposited as core material for core 303. Both up-conversion and pairing contribute to the concentration of Erbium ions left in the ground state, N₁. In some embodiments, the concentration of Erbium ions remaining in the ground state can also be increased by co-doping core 303 with a sensitizer, for example Ytterbium.

FIG. 1B shows a series of energy level diagrams illustrating the up conversion processes in amplifier 300 according to the present invention. Uniformly mono-distributed erbium ions absorb the pump light and amplify signal light by stimulated emission as the ion transitions back to the ground state. Some ground-state erbium ions in erbium clusters, however, absorb both pump and signal light without amplification of the signal. With a high enough pump power, paired erbium ions may both absorb pump photons and both transition to the I_{13/2} state for a short time. The process time of the pair-induced up-conversion can be very short, e.g. about 1 μs. The fast process is due to the short distance between ions in the pair. With limited pumping power density, this up-conversion process can not be saturated. In FIG. 1B, diagram 101 shows both erbium ions in the pair at the ground state. In diagram 102, one of the pairs as absorbed a pump photon and has transitioned to the excited state. In diagram 103, the other erbium ion has absorbed a pump photon and also transitioned to the excited state before the first erbium ion decays to the ground state. In diagram 104, one of the ions has transitioned to the ground state and the other to a higher excited state by pair-induced up-conversion. In diagram 105, the up-converted erbium ion has transitioned back to the excited state. In some cases, the up-converted erbium ion can transition to the ground state or be up-converted again to a higher excited state. One of the erbium ions can be utilized in the amplification process at a time, provided the spontaneous emission occurs before the other ion enters the excited state. Since the pair-induced up-conversion process is so fast, if one of the pairs is already excited and the other becomes excited, the up-conversion process will occur before almost any spontaneous emission can occur. Therefore, the 1530 nm signal can be absorbed by those ions which remain in the ground state.

Paired erbium ions is the simplest example of unsaturable erbium. With higher numbers of erbium ions in the cluster, it is even harder to excite more than two erbium ions in a single cluster simultaneously.

Further, the better confinement of the mode of the pump light in core 303, the higher the non-uniformity of inversion (N₂/N_{Er}) across the cross section of the amplifier. Therefore, the index difference Δn/n between the core and the cladding should be, for example, greater than about 2%.

In some embodiments of the invention, the concentration of unsaturable absorption is varied by varying the starting materials and process conditions for deposition of films for core 303. In some embodiments, the concentration of unsaturable absorption in core 303 can be altered by, for example, ion implantation of erbium ions into the waveguide.

### EXAMPLE 1

A gain-flattened Erbium/Ytterbium co-doped amplifier 300, as shown in FIG. 3C, according to the present invention can be produced. In one example, substrate 301 is a silicon substrate. Undercladding layer 302 is a thermally oxidized SiO₂ layer 15 μm thick. Substrate 301 and layer 302 can be purchased from companies such as Silicon Quest International, Santa Clara, Calif. A layer of active core material is deposited over undercladding layer 302. Active core layer is deposited from a target having the composition Si/Al/Er/Yb being 57.4/41.01.8/0.8 cat. % formed as described in the '247 application by pulsed DC biased deposition as described in the '245 application. Active layer 303 is deposited as about a 1.2 μm layer. Passive layer 305 of aluminasilicate is then deposited over active layer 303. Passive layer 305 of about 4.25 μm thickness can be deposited by pulsed DC biased sputtering as described in the '245 application with a metallic target composition being Si/Al of 87/13 cat. % formed as described in the '247 application. Passive layer 305 and active layer 303 are then patterned by standard lithography techniques to form core 306, which has a width of about 5.0 μm for the active core, and effective length of about 9.3 cm. Upper cladding layer 304 is then deposited from a Si/Al target of 92/8 cat. % formed as described in the '247 application by pulsed DC biased sputter as described in the '245 application. The thickness of cladding layer 304 can be about 10 μm. Amplifier 300 is then annealed at about 725° C. for about 30 min.

The as-deposited Erbium and Ytterbium concentrations in the active layer of core 303 is 2.3×10²⁰ cm⁻³ Erbium concentration and 2.3×10²⁰ cm⁻³ Ytterbium concentration. The index of the core is 1.52 and the index of cladding layers are 1.4458 for undercladding layer 302 and 1.452 for uppercladding layer 304. The parameter Δn/n is therefore about 5.0%.

A reverse taper mode size converter as described in the '138 application is utilized for coupling light into waveguide amplifier 300. The insertion loss at 1310 nm is about 2 dB. FIG. 12 shows the amplifier performance of this example. In FIG. 12, amplifier 300 is pumped with 150 mW from one side pumping with 984 nm light. Gain flattening is achieved within about 1 dB in the range 1528 nm to 1562 nm for small input signals (−20 dBm). For large input signals (0 dBm), gain flattening is also achieved within about 1 dB. For contrast, FIG. 13 shows a high pump power gain parameter spectrum for high pump power (220 mW at 986 nm) for small signals (−20 dBm). As shown in FIG. 13, the pump power is increased, the gain spectrum losses flatness over the C-band.

### EXAMPLE 2

A gain-flattened Erbium doped amplifier 300 as shown in FIG. 3A, according to the present invention can be produced. In one example, substrate 301 is a silicon substrate. Undercladding layer 302 is a thermally oxidized SiO₂ layer 10 μm thick. Substrate 301 and layer 302 can be purchased from companies such as Silicon Quest International, Santa Clara, Calif. A layer of active core material is deposited over undercladding layer 302. Active core layer 303 is deposited from a target having the composition Al/Si/Er being 50.0 cat. % Si, 48.5 cat. % Al, and 1.5 cat. % Er by pulsed DC sputtering as described in the '245 application. Active core layer 303 is deposited with a thickness about 1.2 μm. Active layer 303 is then patterned by standard lithography techniques to form a core 303 that has a width of about 2.5 μm for the active core and length of about 3 cm. Upper cladding layer 304 is then deposited from a Si/Al target of composition 92/8 cat. % by pulsed DC biased sputter as described in the '245 application. The thickness of cladding layer 304 can be about 10 μm. Amplifier 300 is then annealed at about 725° C. for about 30 min.

The as-deposited Erbium concentrations in active layer 303 of core 306 is about 4.5×10²⁰ cm⁻³ Erbium concentration. The index of refraction of core 306 is 1.511 and the index of refraction of cladding layers 302 and 304 are 1.4458 for undercladding layer 302 and 1.452 for uppercladding layer 304. The parameter Δn/n is therefore about 5.0%.

FIG. 6 shows the forward amplifier spontaneous emission of amplifier 300 pumped with 190 mW from one side of 976 rm light. Gain flattening is achieved within about 1 dB in the range 1528 nm to 1562 nm .

### EXAMPLE 3

A gain-flattened Erbium doped amplifier 300, as shown in FIG. 3A, according to the present invention can be produced. In one example, substrate 301 is a silicon substrate. Undercladding layer 302 is a thermally oxidized SiO₂ layer 15 μm thick. Substrate 301 and layer 302 can be purchased from companies such as Silicon Quest International, Santa Clara, Calif. A layer of active core material 303 is deposited over undercladding layer 302. Active core layer 303 is deposited from a target having the composition Si/Al/Er being 54.5 cat. % SiO₂, 44.5 cat. % Al₂O₃, and 1.0 cat. % Er₂O₃ produced as described in the '247 application by RF deposition without bias as described in the '050 application. Layer 303 is deposited with a thickness about 1.2 μm. Active layer 303 is then patterned by standard lithography techniques to form core 306, which in this example has a width of about 4.0 μm and effective length of about 10 cm. Upper cladding layer 304 is then deposited from a Si/Al target of 92 cat. % Si and 8 cat. % Al, by pulsed DC biased sputter as described in the '245 application. The thickness of cladding layer 304 can be about 10 μm. Amplifier 300 is then annealed at 725° C. for about 30 min.

The as-deposited Erbium concentrations in active layer 303 of core 306 is about 2.9×10²⁰ cm⁻³ Erbium concentration. The index of refraction of core 306 is 1.508 and the index of refraction of cladding layers 302 and 304 are 1.4458 for undercladding layer 302 and 1.452 for uppercladding layer 304. The parameter Δn/n is therefore about 4.8%.

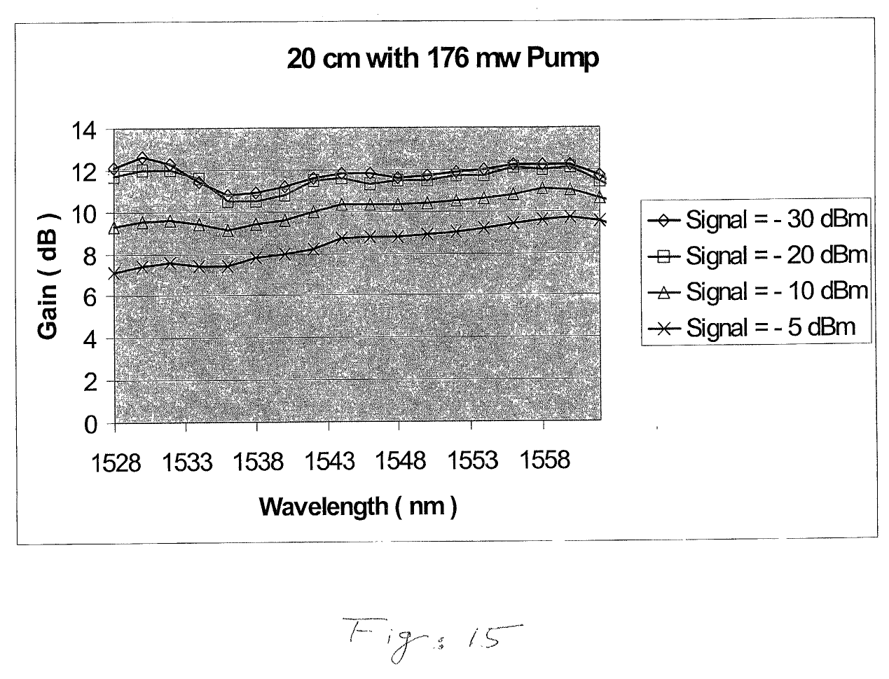

A reverse taper mode size converter as described in the '247 application is utilized for coupling light into waveguide amplifier 300. The insertion loss at 1310 nm is about 2 dB. FIG. 14 shows the amplifier performance of this example. In FIG. 14, amplifier 300 is pumped with 88 mW from one side pumping with 976 nm light. Gain flattening is achieved within about 1.5 dB in the range 1528 nm to 1562 nm for a wide range of input signal power from −30 dBm to −5 dBm.

### EXAMPLE 4

A gain-flattened Erbium co-doped amplifier 300, as shown in FIG. 3B, according to the present invention can be produced. In one example, substrate 301 is a silicon substrate. Undercladding layer 302 is a thermally oxidized SiO₂ layer 10 μm thick. Substrate 301 and layer 302 can be purchased from companies such as Silicon Quest International, Santa Clara, Calif. A layer of passive core material 305 is deposited over undercladding layer 302. Passive core layer is deposited from a target having the composition Si/Al being about 83 cat. % of Si and about 17 cat. % of Al by pulsed DC biased deposition as described in the '245 patent. Layer 305 is deposited to a thickness of about 3.8 μm. Active layer 303 of aluminasilicate is deposited over passive layer 305. Active layer 303 of about 1.1 μm thickness can be deposited by pulsed DC biased sputtering as described in the '245 application with a target composition being about 54.5 cat. % SiO₂, 44.5 cat. % Al₂O₃, and 1.0 cat. % Er₂O₃. Active layer 303 and passive layer 305 are then patterned by standard lithography techniques to form a core 306 that has a width of about 4.0 μm for the active core and effective length of about 20 cm. Upper cladding layer 304 is then deposited from a Si/Al target of 92 cat. % Si and 8 cat. % Al by pulsed DC biased sputter as described in the '245. The thickness of cladding layer 304 can be about 10 μm. Amplifier 300 is then annealed at 725° C. for about 30 min.

The as-deposited Erbium concentrations in active layer 303 of core 306 is 2.9×10²⁰ cm⁻³ The index of refraction of active layer 303 of core 306 is 1.508 and the index of refraction of cladding layers are 1.4458 for undercladding layer 302 and 1.452 for uppercladding layer 304. The parameter Δn/n is therefore about 4.8%.

A two layer mode size converter as described in the '138 application is utilized for coupling light into waveguide amplifier 300. The insertion loss at 1310 nm is about 4 dB. FIG. 15 shows the amplifier performance of this example. In FIG. 15, amplifier 300 is pumped with 176 mW from one side pumping with 976 nm light. Gain flattening is achieved within about 2 dB in the range 1528 nm to 1562 nm for input signal range between −30 dBm and −10 dBm.

The examples and embodiments discussed above are examples only and are not intended to be limiting. One skilled in the art can vary the processes specifically described here in various ways. Further, the theories and discussions of mechanisms presented above are for discussion only. The invention disclosed herein is not intended to be bound by any particular theory set forth by the inventors to explain the results obtained. As such, the invention is limited only by the following claims.

We claim:

1. An optical amplifier, comprising:
a rare earth doped core wherein the a portion of the rare-earth ion is involved in unsaturable absorption,
wherein a distributed absorption of signal light can be created along a length of the amplifier, and
wherein a gain of the amplifier is flat across a band of signal wavelengths.

2. The amplifier of claim 1, wherein the rare earth ion includes erbium.

3. The amplifier of claim 2, wherein a gain of the amplifier varies by less than about 2.5 dB between about 1528 nm and about 1562 mn.

4. The amplifier of claim 2, wherein a gain of the amplifier varies by less than about 2.5 dB for a wide input pump signal power range.

5. The amplifier of claim 4, wherein the wide input signal power range is between about −40 dBm to about 10 dBm.

6. The amplifier of claim 3, wherein a gain of the amplifier varies by less than about 2.5 dB for a wide input pump signal power range.

7. The amplifier of claim 6, wherein the wide input signal power range is between about −40 dBm to about 10 dBm.

8. The amplifier of claim 1, wherein the portion of the rare-earth ion involved in the unsaturable absorption contributes to maintaining a population of rare earth ions present in the ground state.

9. The amplifier of claim 2, wherein the portion of the rare earth ion involved in unsaturable absorption is greater than about 2% of the total erbium concentration.

10. The amplifier of claim 5, wherein an up-conversion constant of the core is greater than about 1×10⁻¹⁸ cm⁻³/s.

12. The amplifier of claim 2, wherein the index difference between the core and a cladding layer surrounding the core is greater than about 2%.

13. The amplifier of claim 1, wherein a length of the core can be adjusted to further flatten the gain.

14. An amplifier according to the present invention, comprising:
means for amplifying a light signal; and
means for creating a distributed absorption along a length of the means for amplifying the light signal,
wherein a gain of the amplifier is flat across a band of wavelengths.

15. The amplifier of claim 14, wherein the means for amplifying the light signal includes an erbium doped core.

16. The amplifier of claim 15, wherein the means for creating a distributed absorption includes providing a concentration of unsaturable erbium throughout the erbium doped core.

17. A method of providing an amplifier with a flat gain across a band of wavelengths, comprising:
providing a core with a concentration of rare earth ions involved in unsaturable absorption; and
pumping the core.

18. The method of claim 17, further including
providing a core with a homogeneous up-conversion constant greater than about 1×10⁻¹⁸ cm³/s.

19. The method of claim 17, further including
providing a cladding layer surrounding the core such that the index difference is greater than about 2%.
